(19) United States
(12) Patent Application Publication
(10) Pub. No.: US 2012/0030582 A1
(43) Pub. Date: Feb. 2, 2012

(54) INFORMATION DELIVERY SYSTEM, INFORMATION DELIVERY SERVER, INFORMATON PRESENTATION TERMINAL, AND INFORMATION DELIVERY METHOD AND PROGRAM

(75) Inventor: Fumitake Muratsu, Tokyo (JP)

(73) Assignee: NEC CORPORATION, Minato-ku, Tokyo (JP)

(21) Appl. No.: 13/260,655

(22) PCT Filed: Mar. 26, 2010
(86) PCT No.: PCT/JP2010/002156

§ 371 Date: Sep. 27, 2011

(30) Foreign Application Priority Data
Mar. 30, 2009 (JP) 2009-081216

(51) Int. Cl. G06F 3/00

(52) U.S. Cl. 715/744

(57) ABSTRACT

An information delivery server of the present invention delivers information to information presentation terminals, and includes a control unit and a storage unit. The storage unit includes: a user attribute information storage unit that stores user attribute information; and a presentation information object storage unit that stores a presentation information object including user presentation information, feature information related to a context and an attribute of the user presentation information, and information indicating a relevancy of the user presentation information to a user of a delivery target. The control unit includes: a relevancy calculation unit which calculates a relevancy of the user presentation information to the user based on user attribute information of the user of the delivery target of the user presentation information and feature information of the user presentation information, and stores the calculated relevancy in the presentation information object storage unit; a delivery management unit that determines an information presentation terminal of a delivery target and a presentation information object to be delivered to the information presentation terminal based on the calculated relevancy at a delivery time of the user presentation information; and a delivery unit that delivers the determined presentation information object to the information presentation terminal of the delivery target.

### TECHNICAL FIELD

The present invention relates to an information delivery technique for delivering appropriate information to an information presentation terminal.

### BACKGROUND ART

In recent years, information provided on the Internet has become excessive. As a result, users can access more information than they can comprehend. Furthermore, it has become difficult for users to obtain the information that they require.

Therefore, there are information delivery systems that present information selected by information delivery servers according to the user's attributes, preferences, and context (for example refer to Patent Document 1).

FIG. 6 is a diagram showing an example of the structure of a conventional information delivery system.

The system shown in FIG. 6 includes an information delivery server 400 that manages information to be presented to a user, and an information presentation terminal 500 that presents the information to the user. The information delivery server 400 includes a user presentation information storage unit 401, a user attribute information storage unit 402, a user presentation information determination unit 403, a user presentation information delivery unit 404, and a query receiving unit 405. The information presentation terminal 500 includes a user presentation information receiving unit 501, an information presentation unit 502, a user context detection unit 503, and a query transmitting unit 504. A query is created based on the user's context detected by the user context detection unit 503. The query transmitting unit 504 transmits the query to the information delivery server 400. The user presentation determination unit 403 selects appropriate information that is adapted to the user's context from the user presentation information storage unit 401. The user presentation information delivery unit 404 delivers the information to the information presentation terminal 500.

For example, a typical search service such as Google (registered trademark) (http://www.google.co.jp) recognizes the query as a search keyword input by the user, selects content adapted to the query among the documentary information on the web at the server side, and presents it to the user.

Moreover, the mobile version of the Google Maps (registered trademark) application (http://www.google.co.jp/mobile/gmm/index.html) uses GPS (GPS: Global Positioning System) information that the terminal can obtain as the user's context and applies it to the query, and as a result presents information to the user according to the user's location.

### PRIOR ART DOCUMENT

### Patent Document

[Patent Document 1] Japanese Unexamined Patent Application, First Publication No. 2003-006525

### SUMMARY OF THE INVENTION

### Problem to be Solved by the Invention

In a system that delivers information adapted to a user as disclosed in Patent Document 1, the processing for determining the information adapted to the user is all performed on the server side. Accordingly, there is a problem in that the load on the information delivery server is dependent on the amount of information delivered and the number of users to whom the information is presented.

Furthermore, in a conventional information delivery system, there is a problem in that when delivering information to the user, in the case where the network communication status between the information delivery server and the information presentation terminal is poor, the information cannot be presented, or even if the information can be presented, it is presented in a situation in which the responsiveness is poor.

Moreover, in the conventional information delivery system, there is a problem in that when transmitting the user's context to the information delivery server side as a query, in the case where the network communication status between the information delivery server and the information presentation terminal is poor, the query is not input to the server side, so that information adapted to the user cannot be selected.

The present invention has been made in consideration of the above points, with an object of delivering and presenting information according to a user's attributes and context to the user's information presentation terminal without increasing the load on the information delivery server and the network communication, and while maintaining high responsiveness by not being influenced by the network communication status.

### Means for Solving the Problem

In order to achieve the aforementioned object, an information delivery server of the present invention delivers information to information presentation terminals, and includes a control unit and a storage unit. The storage unit includes: a user attribute information storage unit that stores user attribute information; and a presentation information object storage unit that stores a presentation information object including user presentation information, feature information related to a context and an attribute of the user presentation information, and information indicating a relevancy of the user presentation information to a user of a delivery target. The control unit includes: a relevancy calculation unit which calculates a relevancy of the user presentation information to the user based on user attribute information of the user of the delivery target of the user presentation information and feature information of the user presentation information, and stores the calculated relevancy in the presentation information object storage unit; a delivery management unit that determines an information presentation terminal of a delivery target and a presentation information object to be delivered to the information presentation terminal based on the calculated relevancy at a delivery time of the user presentation information; and a delivery unit that delivers the determined presentation information object to the information presentation terminal of the delivery target.

Furthermore, the information delivery server may further includes a delivery history information storage unit that stores delivery history of the presentation information object delivered to the information presentation terminal, and when the user attribute information or the user presentation information is updated, the relevancy calculation unit may recalculate a relevancy of the user presentation information using the updated user attribute information or the updated feature information of the user presentation information, the delivery management unit may determine an information presentation terminal of a delivery target and a presentation information object to be delivered to the information presentation terminal based on the recalculated relevancy, and the delivery unit may deliver a presentation information object to the information presentation terminal after excluding the presentation information object stored in the delivery history from the determined presentation information object.

An information presentation terminal of the present invention receives from an information delivery server, a presentation information object including user presentation information, feature information related to a context and an attribute of the user presentation information, and information indicating a relevancy of the feature information and the user attribute information held by the information delivery server. The information presentation terminal includes a storage unit that stores the presentation information object, and a control unit. The control unit includes a user context detection unit that detects user context, a relevancy correction unit that corrects a relevancy of the user presentation information based on the detected user context and the feature information of the user presentation information at a presentation timing of the user presentation information, an information presentation unit that determines user presentation information to be output based on the corrected relevancy, and an output unit that outputs the determined user presentation information.

The information presentation terminal of the present invention may further include a sensor, and a sensor information collection unit that collects sensor information detected by the sensor, and a point of time when a change occurs in the sensor information or the user context may be determined to be the presentation timing of the user information.

An information delivery system of the present invention includes an information delivery server, and an information presentation terminal that is connected to the information delivery server such that data communication is possible. The information delivery server includes: a presentation information object storage unit that stores a presentation information object including user presentation information, feature information related to a context and an attribute of the user presentation information, and information indicating a relevancy of the user presentation information to a user of a delivery target; a user attribute information storage unit that stores user attribute information; a relevancy calculation unit that calculates a relevancy of the user presentation information to the user based on user attribute information of the user of the delivery target of the user presentation information and feature information of the user presentation information, and stores the calculated relevancy in the presentation information object storage unit; a delivery management unit that determines an information presentation terminal of a delivery target and a presentation information object to be delivered to the information presentation terminal based on the calculated relevancy at a delivery time of the user presentation information; and a delivery unit that delivers the determined presentation information object to the information presentation terminal of the delivery target. The information presentation terminal includes: a storage unit that stores the presentation information object transmitted from the information delivery server; a user context detection unit that detects user context; a relevancy correction unit that corrects a relevancy of the user presentation information based on the detected user context and the feature information of the user presentation information at a presentation timing of user presentation information; an information presentation unit that determines user presentation information to be output based on the corrected relevancy; and an output unit that outputs the determined user presentation information.

An information delivery method of the preset invention delivers, from an information delivery server to an information presentation terminal, a presentation information object including user presentation information, feature information related to a context and an attribute of the user presentation information, and information indicating a relevancy of the user presentation information to a user of a delivery target. The information delivery method includes the steps of: calculating a relevancy of the user presentation information to the user based on user attribute information of the user of the delivery target and feature information of the user presentation information at a delivery time of the user presentation information, by the information delivery server; determining an information presentation terminal of a delivery target and a presentation information object to be delivered to the information presentation terminal based on the calculated relevancy, by the information delivery server; delivering the determined presentation information object to the information presentation terminal of the delivery target by the information delivery server; storing the presentation information object transmitted from the information delivery server by the information presentation terminal; detecting user context by the information presentation terminal; correcting a relevancy of the user presentation information based on the detected user context and the feature information of the user presentation information at a presentation timing of the user presentation information, by the information presentation terminal; determining user presentation information to be output based on the corrected relevancy by the information presentation terminal; and outputting the determined user presentation information by the information presentation terminal.

A program according to a first aspect of the present invention operates a computer connected to an information presentation terminal so as to be able to transmit and receive data as: a user attribute information storage unit that stores user attribute information; a presentation information object storage unit that stores a presentation information object including user presentation information, feature information related to a context and an attribute of the user presentation information, and information indicating a relevancy of the user presentation information to a user of a delivery target; a relevancy calculation unit that calculates a relevancy of the user presentation information to the user based on user attribute information of the user of the delivery target of the user presentation information and feature information of the user presentation information and stores the calculated relevancy in the presentation information object storage unit; a delivery management unit that determines an information presentation terminal of a delivery target and a presentation information object to be delivered to the information presentation terminal based on the calculated relevancy at a delivery time of the user presentation information; and a delivery unit that delivers the determined presentation information object to the information presentation terminal of the delivery target.

A program according to a second aspect of the present invention operates a terminal connected to an information delivery server so as to be able to transmit and receive data as: a storage unit that stores a presentation information object including user presentation information, feature information related to a context and an attribute of the user presentation information, and information indicating a relevancy of the feature information and the user attribute information held by the information delivery server, which are transmitted from the information delivery server; a user context detection unit that detects user context; a relevancy correction unit that corrects a relevancy of the user presentation information based on the detected user context and the feature information of the user presentation information at a presentation timing of the user presentation information; an information presentation unit that determines user presentation information to be output based on the corrected relevancy; and an output unit that outputs the determined user presentation information.

### Effect of the Invention

According to an exemplary embodiment of the present invention, it is possible to present information adapted to a user's context to the information presentation terminal with high responsiveness regardless of the network communication state between an information delivery server and an information presentation terminal.

This is due to the following reason. The information delivery server delivers information to the information presentation terminal at time decided by itself. User presentation information, which is a candidate of presentation, is delivered to the information presentation terminal in advance through the network. The user presentation information to be presented in the information presentation terminal is in a state in which it can be selected in a closed format on the basis of the user context.

Furthermore, according to an exemplary embodiment of the present invention, it is possible to improve the user context adaptability of the information to be presented to the user while reducing the load of the network communication environment and the server.

This is because the information delivery server delivers information adapted to the user to a certain degree to the information presentation terminal in advance, and the information presentation terminal itself selects the user presentation information to be presented on the basis of the user presentation information in the terminal that has already been delivered and the user context information detected on the basis of the sensor provided in the terminal and the software usage history.

Moreover, according to an exemplary embodiment of the present invention, it is possible to receive an information presentation service adapted to a user's context without leaking user context information concerning the user's privacy to outside of the terminal.

### BRIEF DESCRIPTION OF THE DRAWINGS

FIG. 1 is a functional block structural diagram of an information delivery system according an exemplary embodiment of the present invention.

FIG. 2 is a diagram showing the structure of a presentation information object according to the exemplary embodiment of the present invention.

FIG. 3 is a diagram showing the structure of the presentation information object according to the exemplary embodiment of the present invention after correction.

FIG. 4 is a sequence diagram showing the flow of presentation information delivery processing of the information delivery system according to the exemplary embodiment of the present invention.

FIG. 5 is a sequence diagram showing the flow of the processing of differential information delivery processing of the information delivery system according to the exemplary embodiment of the present invention.

FIG. 6 is a functional block structural diagram of a conventional information delivery system.

### EMBODIMENTS FOR CARRYING OUT THE INVENTION

Hereunder is a detailed description of a preferred exemplary embodiment of the present invention, with reference to the appended drawings.

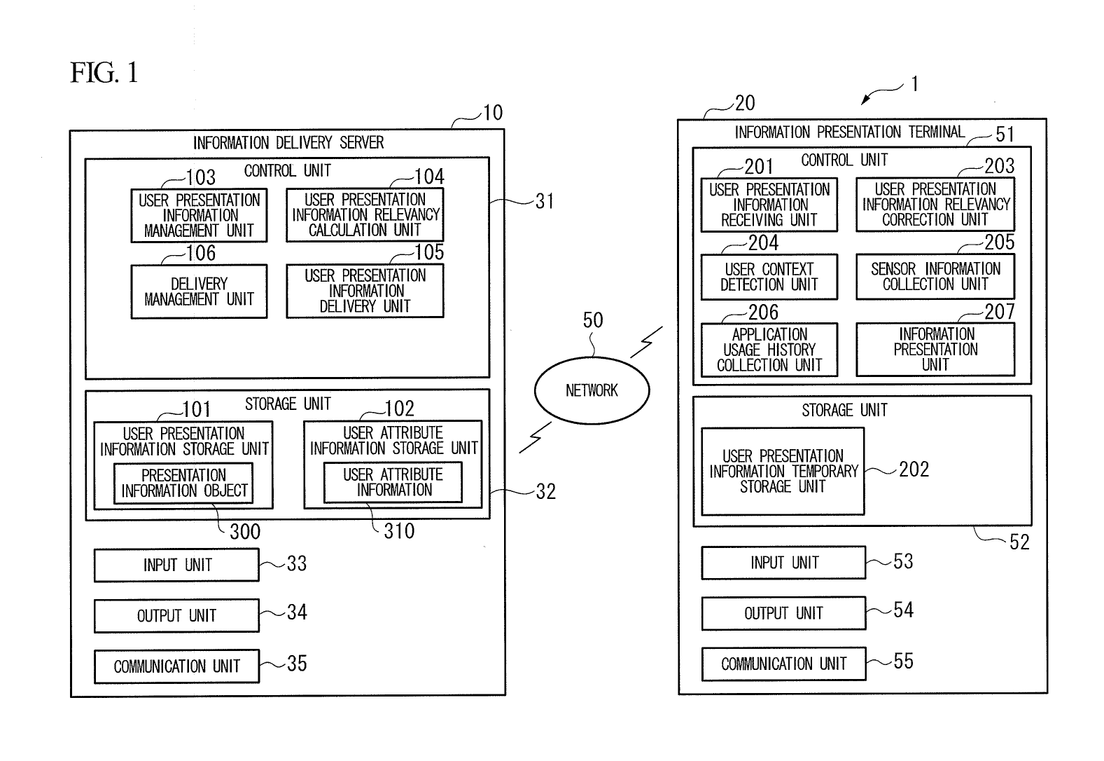

FIG. 1 is a functional block structural diagram of an information delivery system 1. The information delivery system 1 includes an information delivery server 10 and an information presentation terminal 20. The information delivery server 10 and the information presentation terminal 20 are connected via a network 50 such that they can communicate data. The network 50 is the Internet or the like. The data communication may be wireless communication, or wired communication. A case will be described, as an example, in which the information delivery server 10 delivers information to the information presentation terminal 20, and the information presentation terminal 20 presents the information to a user.

The information delivery server 10 is a computer server, for example. The information delivery server 10 includes a control unit 31, a storage unit 32, an input unit 33, an output unit 34, and a communication unit 35. The control unit 31 is a central processing unit (CPU) or a microprocessor, or the like. The control unit 31 controls the other parts, and includes a user presentation information management unit 103, a user presentation information relevancy calculation unit 104, a user presentation information delivery unit 105, and a delivery management unit 106.

The storage unit 32 is a storage device such as a nonvolatile memory, a volatile memory, or a hard disc, for example. The storage unit 32 includes a user presentation information storage unit 101 and a user attribute information storage unit 102, and stores a program or the like to perform processing, which is described later.

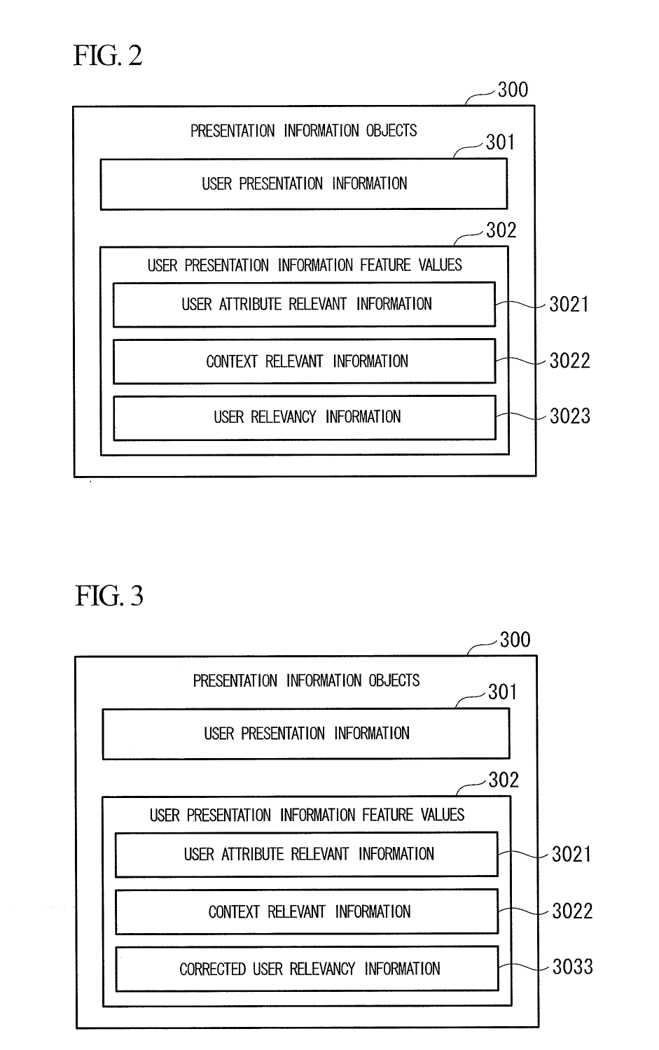

The user presentation information storage unit 101 stores a presentation information object 300. FIG. 2 is a diagram showing the structure of the presentation information object. The presentation information object 300 includes user presentation information 301 and user presentation information feature values 302. The user presentation information 301 is information to be delivered to a user of the information presentation terminal 20, for example business information, store merchandise information, or service guide information.

The user information feature amount 302 includes user attribute relevant information 3021, context relevant information 3022, and user relevancy 3023. The user presentation information feature amount 302 is feature information, which is a basis for determining which terminal the user presentation information 301 is to be delivered to, and at what timing it is presented to the user.

The user attribute relevant information 3021 is information that describes features associated with the user's attributes and preferences among the features held by the user presentation information 301. For example, if the user presentation information 301 is restaurant information, the user attribute relevant information 3021 is information that shows the genre of the restaurants (Japanese food, Western food, Chinese food), target class (gender, age, occupation, and the like), and, furthermore, menus that are offered.

The context relevant information 3022 is information that describes features associated with candidate of user context that the user can obtain among the features that are held by the user presentation information 301. For example, if the user presentation information 301 is information about a restaurant, the context relevant information 3022 may be information about the location of the restaurant, the business hours (from 10:00 to 20:00, or the like), the number of people (for one person, for two people, for a group, or the like) to which it is suited.

The user relevancy information 3023 is the relevancy (score) indicating to what degree the user presentation information 301 matches the attributes and context of a target user. For example, it may be set such that the higher the score of the relevancy of the user relevancy information 3023, the better it matches the attributes and context of the user.

The user relevancy information 3023 does not have an effective score at the stage at which it is stored in the user presentation information storage unit 101. The score is calculated by the user presentation information relevancy calculation unit 104, which is described later.

Returning to FIG. 1, the user attribute information storage unit 102 stores the user attribute information 310. The user attribute information 310 is information regarding the attributes (name, address, gender, age, etc.) and preferences of the user, which are obtained in advance by interviewing the user, being an information presentation target, or a statistical technique such as a Bayesian network.

The user presentation information management unit 103 analyzes the user presentation information object 300 stored in the user presentation information storage unit 101, and transfers information broken down appropriately into the formats of the user presentation information 301 and the user presentation information feature amount 302 to other units.

The user presentation information relevancy calculation unit 104 assigns effective scores to the user relevancy information 3023. The score becomes diagnostic criterion when determining which user presentation information 301 is to be delivered to which information presentation terminal 20. The user presentation information relevancy calculation unit 104 compares the user presentation information feature amount 302 obtained from the user presentation information management unit 103 and the user attribute information 310 obtained from the user attribute information storage unit 102, and determines a score to be assigned to the user relevancy information 3023.

The user presentation information delivery unit 105 delivers the user presentation information object 300 to which the score obtained from the user presentation information relevancy calculation unit 104 has been assigned, to the information presentation terminal 20.

The delivery management unit 106 determines the delivery timing, and which content of the presentation information object 300 to deliver to which information presentation terminal 20, and requests the user presentation information delivery unit 105 to deliver it.

The delivery timing and the delivery target information presentation terminal 20 are determined on the basis of policies that describe the state of the information presentation terminal 20 environment, and the user conditions under which delivery is performed.

For example, if the policy describes that delivery is performed regularly in a specific time range (midnight or the like) each day, the delivery management unit 106 requests delivery by the user presentation information delivery unit 105, as a trigger that it has reached the specific time range.

If the policy describes that delivery is performed to a user who has passed through a ticket gate at a certain station, when the delivery management unit 106 detects that the user has passed through the ticket gate at the station determined in the policy as a user context, it requests delivery by the user presentation information delivery unit 105 to the information presentation terminal 20 of the user.

The delivery management unit 106 selects and determines the presentation information object 300 to be delivered on the basis of the score of the user relevancy information 3023 calculated by the user presentation information relevancy calculation unit 104. For example, the delivery management unit 106 selects presentation information objects 300 with higher scores calculated in order, and determines the set of presentation information objects 300 on the basis of an upper threshold value of the presentation information object 300 determined in advance, over all the data sizes and the like.

Furthermore, the delivery management unit 106 stores the user presentation information object 300 that has already been delivered to the information presentation terminal 20 in the storage unit 32. The delivery management unit 106 compares the user presentation information object 300 that has already been delivered and the set of the presentation information object 300 that has newly been determined to be delivered, and instructs the user presentation information delivery unit 105 to transmit only differential changed information.

The input unit 33 of the information delivery server 10 is an input device such as a keyboard or a mouse. The output unit 35 is an output device such as a display device. The communication unit 35 is a device that transmits and receives data to and from the information presentation terminal 20 via the network 50.

The information presentation terminal 20 is a portable terminal including a portable telephone, a computer, or the like, and includes a control unit 51, a storage unit 52, an input unit 53, an output unit 54 and a communication unit 55.

The control unit 51 is a central processing unit (CPU), a microprocessor or the like, and performs control the other parts and information presentation processing, which is described later. The storage unit 52 is a storage device such as a nonvolatile memory, a volatile memory, or a hard disc, for example. The input unit 53 is an input device such as an operation button or a keyboard. The output unit 54 is an output device such as a display or a speaker. The communication unit 55 is a device that transmits and receives data to and from the information delivery server 10 via the network 50.

The control unit 51 includes a user presentation information receiving unit 201, a user presentation information relevancy correction unit 203, a user context detection unit 204, a sensor information collection unit 205, an application usage history collection unit 206, and an information presentation unit 207.

The user presentation information receiving unit 201 receives the presentation information object 300 delivered from the user presentation information delivery unit 105 of the information delivery server 10. When receiving, since the delivery timing of the user presentation information delivery unit 105 is controlled dependent on the policy, the user presentation information receiving unit 201 operates in a standby state so that it can receive at arbitrary timing.

The storage unit 52 has a user presentation information temporary storage unit 202.

The user presentation information temporary storage unit 202 stores the presentation information objects 300 received by the user presentation information receiving unit 201 temporarily.

At this time, the user presentation information receiving unit 201 controls the content of the user presentation information objects 300 stored in the user presentation information temporary storage unit 202. For example, in the case where the user presentation information receiving unit 201 receives a set of new user presentation information objects 300, the user presentation information receiving unit 201 performs processing such as destroying all of the previously stored user presentation information objects 300. Moreover, in the case where the user presentation information receiving unit 201 receives only differential information of the user presentation information object 300, the user presentation information receiving unit 201 updates only the differences of the target user presentation information object 300.

The user presentation information relevancy correction unit 203 selects context relevant information 3022 contained in the user presentation information object 300, from the user presentation information temporary storage unit 202, compares the information with user context information obtained from the user context detection unit 204, and calculates a correction score of the user relevancy.

FIG. 3 is a diagram showing a presentation information object to which the correction score is added. The user presentation information relevancy correction unit 203 adds the calculated correction score to the user relevancy information 3023 score contained in the user presentation information object 300 stored in the user presentation information temporary storage unit 202, and stores it in the user presentation information temporary storage unit 202 as corrected user relevancy information 3033. In this manner, the corrected user relevancy information 3033 includes a score that considers the user attribute and the user context at the time of evaluation.

The sensor information collection unit 205 obtains sensor information from a physical sensor (not shown in the figure) or the like, which is installed in the information presentation terminal 20, and notifies it to the user context detection unit 204. The sensor information is latitude and longitude information, which can be obtained from a GPS, beacon information (SS-ID) of a wireless LAN access point in the surroundings, which can be obtained from a wireless LAN device, or the like, for example.

The application usage history collection unit 206 collects usage log information when a user uses an application installed in the information presentation terminal 20. For usage log information, to be specific, the command content of the application that the user has actually operated, or the time that the command was executed, and the like, can be considered.

The user context detection unit 204 obtains the user context from the sensor information collected by the sensor information collection unit 205 and the application usage history information collected by the application usage history collection unit 206. The obtained user context is notified to the user presentation information relevancy correction unit 203.

The information presentation unit 207 selects the user presentation information 301 to be presented on the basis of the corrected user relevancy information 3033 that the user presentation information relevancy correction unit 203 has corrected, and presents it to the user by outputting it to the output unit 54.

The user presentation information 301 may be presented by being displayed to a user visually via a GUI incorporated in the information presentation terminal 20. Alternatively, the user presentation information 301 may be presented by allowing it to be heard audibly or felt tactilely using a speaker, a vibration device, or the like.

One or a plurality of items of user presentation information 301 may be selected and presented. In the case where there is a plurality of user presentation information 301, the objects to be presented may be those with the highest scores of the corrected user relevancy information 3033, or an irregular selection method may be used in which only one that has an intermediate score is likely to be selected at random.

Next is a description of the operation of the information delivery system 1.

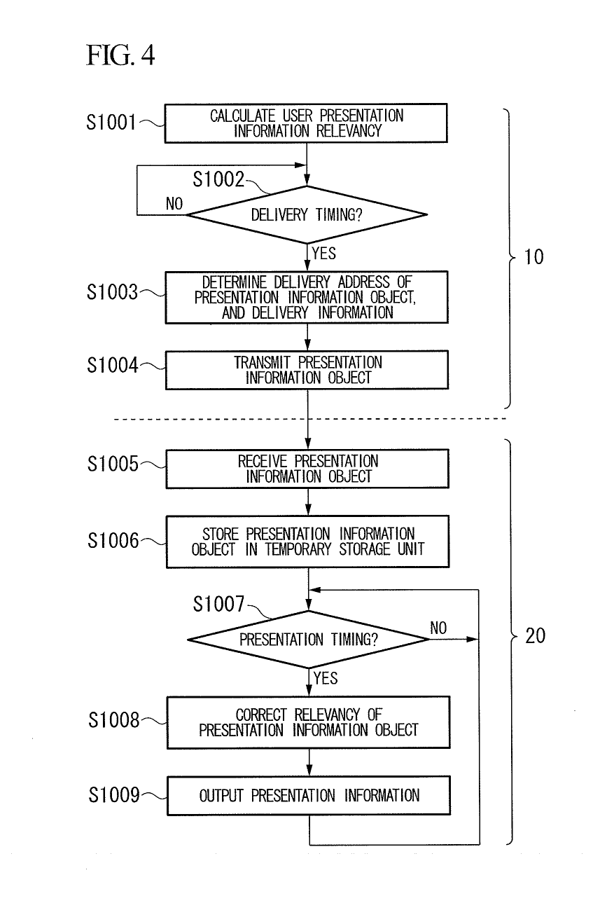

FIG. 4 is a sequence diagram showing the flow of information delivery processing and presentation processing of the information delivery system 1.

The user presentation information relevancy calculation unit 104 of the information delivery server 10 determines the priority of the presentation information object 300 to be stored in the user presentation information storage unit 101 (step S1001). The priority is evaluated with respect to all of the presentation information objects 300 stored in the user presentation information storage unit 101. In the case where the number of evaluation objects to be prioritized is high, the evaluation processing of the priority can also be performed continuously in the background.

Next, the delivery management unit 106 evaluates at what timing the user presentation information object 300 is to be delivered to the information presentation terminal 20 (step S1002). If the delivery management unit 106 determines that it is delivery time, the delivery management unit 106 determines the user presentation information object 300 of a delivery target, and the information presentation terminal 20, being the delivery address of the user presentation information object 300 (step S1003).

A specific decision method of the delivery timing and the delivery target information presentation terminal 20, which are determined in step S1003, will be described.

One method is to divide the information presentation terminals 20 into a plurality of groups for delivery, which are delivered to at once in a time series, with an aim of distributing the network load during delivery. At this time, the determining factor of the delivery timing is time. If the presentation information object 300 transmission is distributed, it is possible to reduce the network communication load.

Another method is to detect a user who satisfies specific conditions using user presence information (for example, passing through a station ticket gate, shifting mobile telephone base stations, etc.) detectable on the network side, and make the information presentation terminal 20 held by the user the delivery object. At this time, the delivery timing is when the delivery target user satisfies the conditions.

Next, the user presentation information delivery unit 105 of the information delivery server 10 delivers the user presentation information object 300 selected in step S1003 to the target information presentation terminal 20 (step S1004).

The user presentation information receiving unit 201 of the information presentation terminal 20 receives the presentation information object 300 delivered from the information delivery server 10 (step S1005), and stores the presentation information object 300 in the user presentation information temporary storage unit 202 (step S1006).

Next, the user presentation information relevancy correction unit 203 of the information presentation terminal 20 determines whether or not to instruct the output unit 54 to output the user presentation information 301 of the presentation information object 300 stored in step S1006 (step S1007).

The output timing of the user presentation information 301 is determined as follows.

There is a case where there is a request for information presentation by the user's operation of the input unit 53 such as an operation button. In this case, the event of the user requesting information presentation is notified to the user presentation information relevancy correction unit 203, and processing moves to the next step S1008.

There is another case where a change is detected in the user context. To be specific, a case is considered in which the location of the user is shifted from one defined region to another region. In this case, the user context detection unit 204 detects the change of the user context, informs it to the user presentation information relevancy correction unit 203, and processing shifts to the next step S1008.

If it is determined that it is presentation time in step S1007, the user presentation information relevancy correction unit 203 of the information presentation terminal 20 corrects the score of the user relevancy information 3023 contained in the presentation information object 300 (step S1008).

The information presentation unit 207 determines the user presentation information 301 to be presented on the basis of the score corrected in this manner, and outputs it to the output unit 54 (step S1009).

After passing through step S1009, the information presentation terminal 20 returns to step S1007, detects the button operation by the user and the user context, and seeks a time to present the presentation information object again.

As described above, in the present information delivery system 1, at a point in time that the network communication environment is not affected, the information delivery server 10 transmits the presentation information object 300 that is adapted to the user at the point in time to the information presentation terminal 20 of the user. The information presentation terminal 20 stores the received presentation information object 300, and, notifies information adapted to the detected user context to the user.

Accordingly, in the present information delivery system 1, it is possible to deliver information adapted to the user's attributes and context without loading the network communication environment and the information delivery server.

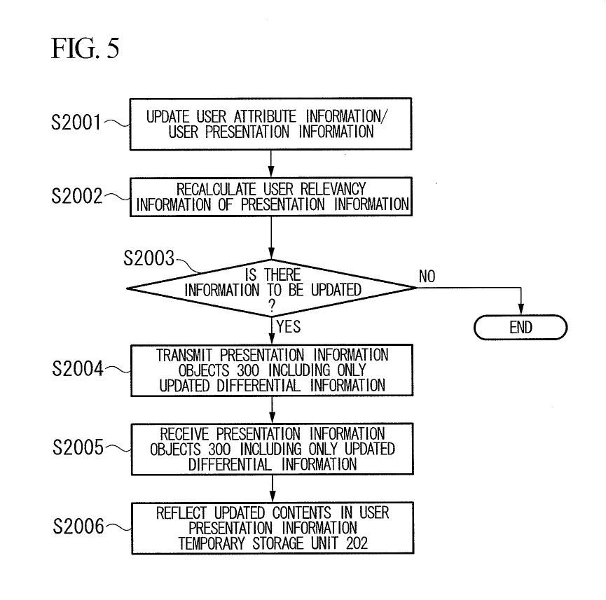

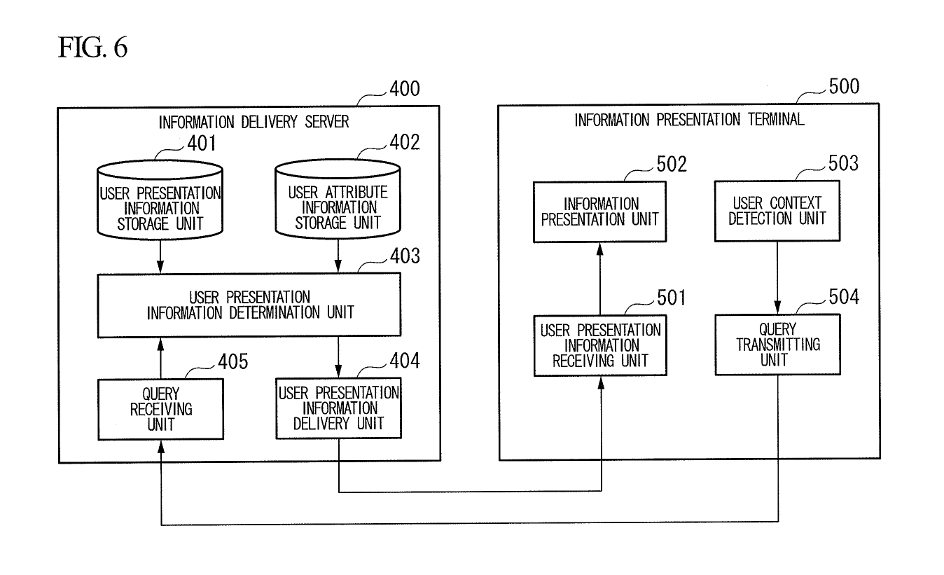

Next is a description, using FIG. 5, of the delivery of differential information and the presentation processing in the information delivery system 1.

If the presentation information object 300 or the user attribute information 310, which are stored in the storage unit 32 of the information delivery server 10, are newly added to or modified (step S2001), the user presentation information relevancy calculation unit 104 recalculates the score (relevancy) of the user relevancy information 3023 of the presentation information object 300 (step S2002).

There are cases where additions and updates to the presentation information objects 300 and the user attribute information 310 are made manually through a Web interface, a setting file, or the like, or cases where they are automatically calculated on the basis of the behavior history information of the user, which has been collected by some method, so it is assumed such that the result is updated as new user attribute information 310. The recalculation processing of the relevancy is performed on the basis of the new user presentation information object 300 and user attribute information updated in step S2001.

Next, the delivery management unit 106 of the information delivery server 10 determines whether or not there is information to be updated in the user presentation information object 300 stored temporarily in the information presentation terminal 20 according to the result of the processing in step S2001 and step S2002 (step S2003).

The delivery history information of the presentation information objects delivered to each of the information presentation terminals 20 is stored in the storage unit 32. Furthermore, a new user presentation information object 300 is selected by the result of the score of the user relevancy information 3023 calculated in step S2002. The delivery management unit 106 determines whether there is information to be updated, and the information presentation terminal 20, which is the delivery address of the information to be updated, by comparing the delivery history information of the presentation information object and the new user presentation information object 300.

In step S2003, in the case where there is no information to be updated, processing is terminated.

In step S2003, in the case where there is information to be updated, the user presentation information delivery unit 105 transmits differential information of the user presentation information object 300 to the information presentation terminal 20 according to the delivery content (step S2004). The differential information is the presentation information objects of the set of presentation information objects 300 newly selected as delivery objects from which are excluded the presentation information objects that have already been delivered to the information presentation terminal 20, which is the delivery address, and stored in the delivery history information.

The user presentation information receiving unit 201 of the presentation information terminal 20 receives the transmitted differential information of the user presentation information objects 300 (step S2005), and stores the differential information in the user presentation information temporary storage unit 202 (step S2006).

The updated user presentation information objects 300 stored in the information presentation terminal 20 in step S2006 are presented to the user similarly to step S1007 to step S1009 of FIG. 4.

In this manner, even in the case where the presentation information objects 300 or the user attribute information 310 are updated, the information delivery server 10 can deliver the differential of the presentation information objects without considering the user's context. On the other hand, the information presentation terminal 20 can select appropriate information at this point of time in consideration of the context and notify it to the user.

In this manner, according to the present exemplary embodiment, it is possible to realize the presentation of information according to the user's attributes and context while minimizing the communication load of the information delivery server 10 and the information presentation terminal 20 as much as possible, and without damaging the responsiveness to the user.

It is possible to realize the information delivery server 10 by creating a program for realizing the user presentation information management unit 103, the user presentation information relevancy calculation unit 104, the user presentation information delivery unit 105, and the delivery management unit 106, and by a general purpose computer reading the program.

Furthermore, it is possible to realize the information delivery information presentation terminal 20 by creating a program for realizing the user presentation information receiving unit 201, the user presentation information relevancy correction unit 203, the user context detection unit 204, the sensor information collection unit 205, the application usage history collection unit 206, and the information presentation unit 207, and by a portable telephone or the like reading the program.

These programs may be stored in a recording medium such as a CD-ROM for distribution, or they may also be distributed via a network.

As above, the exemplary embodiment of the present invention is described in detail with reference to the drawings. However, specific constructions are not limited to this exemplary embodiment, and any design change or the like that does not depart from the scope of the invention is included.

This application is based upon and claims the benefit of priority from Japanese patent application No. 2009-081216, filed on Mar. 30, 2009, the disclosure of which is incorporated herein in its entirety by reference.

### INDUSTRIAL APPLICABILITY

The present invention may be applied to an information delivery system. According to this information delivery system, it is possible to deliver and present information according to a user's attributes and context to the user's information presentation terminal without increasing the load on the information delivery server and the network communication, and while maintaining high responsiveness by not being influenced by the network communication status.

### REFERENCE SYMBOLS

1 Information delivery system
10 Information delivery server
20 Information presentation terminal
31 Control unit
32 Storage unit
33 Input unit
34 Output unit
35 Communication unit
51 Control unit
52 Storage unit
53 Input unit
54 Output unit
55 Communication unit
101 User presentation information storage unit
102 User attribute information storage unit
103 User presentation information management unit
104 User presentation information relevancy calculation unit
105 User presentation information delivery unit
106 Delivery management unit
201 User presentation information receiving unit
202 User presentation information temporary storage unit
203 User presentation information relevancy correction unit
204 User context detection unit
205 Sensor information collection unit
206 Application usage history collection unit
205 Information presentation unit
300 Presentation information object
310 User attribute information

1. An information delivery server that delivers information to information presentation terminals, and comprises a control unit and a storage unit,
the storage unit comprising:
a user attribute information storage unit that stores user attribute information; and
a presentation information object storage unit that stores a presentation information object including user presentation information, feature information related to a context and an attribute of the user presentation information, and information indicating a relevancy of the user presentation information to a user of a delivery target, and
the control unit comprising:
a relevancy calculation unit which calculates a relevancy of the user presentation information to the user based on user attribute information of the user of the delivery target of the user presentation information and feature information of the user presentation information, and stores the calculated relevancy in the presentation information object storage unit;
a delivery management unit that determines an information presentation terminal of a delivery target and a presentation information object to be delivered to the information presentation terminal based on the calculated relevancy at a delivery time of the user presentation information; and
a delivery unit that delivers the determined presentation information object to the information presentation terminal of the delivery target.

2. The information delivery server according to claim 1, further comprising:
a delivery history information storage unit that stores delivery history of the presentation information object delivered to the information presentation terminal,
wherein when the user attribute information or the user presentation information is updated,
the relevancy calculation unit recalculates a relevancy of the user presentation information using the updated user attribute information or the updated feature information of the user presentation information,
the delivery management unit determines an information presentation terminal of a delivery target and a presentation information object to be delivered to the information presentation terminal based on the recalculated relevancy, and
the delivery unit delivers a presentation information object to the information presentation terminal after excluding the presentation information object stored in the delivery history from the determined presentation information object.

3. An information presentation terminal that receives from an information delivery server, a presentation information object including user presentation information, feature information related to a context and an attribute of the user presentation information, and information indicating a relevancy of the feature information and the user attribute information held by the information delivery server, the information presentation terminal comprising:
a storage unit that stores the presentation information object; and
a control unit, the control unit comprising
a user context detection unit that detects user context,
a relevancy correction unit that corrects a relevancy of the user presentation information based on the detected user context and the feature information of the user presentation information at a presentation timing of the user presentation information,
an information presentation unit that determines user presentation information to be output based on the corrected relevancy, and
an output unit that outputs the determined user presentation information.

4. The information presentation terminal according to claim 3, further comprising:
a sensor; and
a sensor information collection unit that collects sensor information detected by the sensor,
wherein a point of time when a change occurs in the sensor information or the user context is determined to be the presentation timing of the user information.

5. An information delivery system comprising an information delivery server, and an information presentation terminal that is connected to the information delivery server such that data communication is possible,
the information delivery server comprising:
a presentation information object storage unit that stores a presentation information object including user presentation information, feature information related to a context and an attribute of the user presentation information, and information indicating a relevancy of the user presentation information to a user of a delivery target;
a user attribute information storage unit that stores user attribute information;
a relevancy calculation unit that calculates a relevancy of the user presentation information to the user based on user attribute information of the user of the delivery target of the user presentation information and feature information of the user presentation information, and stores the calculated relevancy in the presentation information object storage unit;
a delivery management unit that determines an information presentation terminal of a delivery target and a presentation information object to be delivered to the information presentation terminal based on the calculated relevancy at a delivery time of the user presentation information; and
a delivery unit that delivers the determined presentation information object to the information presentation terminal of the delivery target, and
the information presentation terminal comprising:
a storage unit that stores the presentation information object transmitted from the information delivery server;
a user context detection unit that detects user context;
a relevancy correction unit that corrects a relevancy of the user presentation information based on the detected user context and the feature information of the user presentation information at a presentation timing of user presentation information;
an information presentation unit that determines user presentation information to be output based on the corrected relevancy; and
an output unit that outputs the determined user presentation information.

6. An information delivery method for delivering, from an information delivery server to an information presentation terminal, a presentation information object including user presentation information, feature information related to a context and an attribute of the user presentation information, and information indicating a relevancy of the user presentation information to a user of a delivery target, the information delivery method comprising the steps of:
calculating a relevancy of the user presentation information to the user based on user attribute information of the user of the delivery target and feature information of the user presentation information at a delivery time of the user presentation information, by the information delivery server;
determining an information presentation terminal of a delivery target and a presentation information object to be delivered to the information presentation terminal based on the calculated relevancy, by the information delivery server;
delivering the determined presentation information object to the information presentation terminal of the delivery target by the information delivery server;
storing the presentation information object transmitted from the information delivery server by the information presentation terminal;
detecting user context by the information presentation terminal;
correcting a relevancy of the user presentation information based on the detected user context and the feature information of the user presentation information at a presentation timing of the user presentation information, by the information presentation terminal;
determining user presentation information to be output based on the corrected relevancy by the information presentation terminal; and
outputting the determined user presentation information by the information presentation terminal.

7. A computer readable recording medium storing a program that operates a computer connected to an information presentation terminal so as to be able to transmit and receive data as:
a user attribute information storage unit that stores user attribute information;
a presentation information object storage unit that stores a presentation information object including user presentation information, feature information related to a context and an attribute of the user presentation information, and information indicating a relevancy of the user presentation information to a user of a delivery target;
a relevancy calculation unit that calculates a relevancy of the user presentation information to the user based on user attribute information of the user of the delivery target of the user presentation information and feature information of the user presentation information and stores the calculated relevancy in the presentation information object storage unit;
a delivery management unit that determines an information presentation terminal of a delivery target and a presentation information object to be delivered to the information presentation terminal based on the calculated relevancy at a delivery time of the user presentation information; and
a delivery unit that delivers the determined presentation information object to the information presentation terminal of the delivery target.

8. A computer readable recording medium storing a program that operates a terminal connected to an information delivery server so as to be able to transmit and receive data as:
a storage unit that stores a presentation information object including user presentation information, feature information related to a context and an attribute of the user presentation information, and information indicating a relevancy of the feature information and the user attribute information held by the information delivery server, which are transmitted from the information delivery server;
a user context detection unit that detects user context;
a relevancy correction unit that corrects a relevancy of the user presentation information based on the detected user context and the feature information of the user presentation information at a presentation timing of the user presentation information;
an information presentation unit that determines user presentation information to be output based on the corrected relevancy; and
an output unit that outputs the determined user presentation information.
